(19) United States
(12) Patent Application Publication
(10) Pub. No.: US 2025/0281888 A1
(43) Pub. Date: Sep. 11, 2025

(54) GAS/LIQUID MIXER VIA DILUTION AND DIVISION

(71) Applicants: L'Air Liquide, Société Anonyme pour l'Etude et l'Exploitation des Procédés Georges Claude, Paris (FR); Air Liquide France Industrie, Paris (FR)

(72) Inventors: Franck COUSIN, Saint Brevin les Pins (FR); Bruno ALBAN, Verrieres le Buisson (FR); Dominique IBARRA, Gif-sur-Yvette (FR)

(21) Appl. No.: 19/071,530

(22) Filed: Mar. 5, 2025

(30) Foreign Application Priority Data
Mar. 8, 2024 (FR) FR2402335

(51) Int. Cl. B01F 23/233; B01F 27/1143

(52) U.S. Cl. CPC B01F 23/23311; B01F 27/1143

(57) ABSTRACT

Device for mixing a gas into a liquid, implementing a screw structure in a pipe in which the liquid is able to circulate, and also means for injecting the gas at one or more points into the pipe, characterized in that:
the first zone encountered by the liquid has a screw portion within which the shaft is a pipe pierced with orifices, the liquid to be treated passing through the space inside the pipe surrounding the shaft, while the gas is distributed inside the shaft and discharges via the orifices into the liquid;
the second zone encountered by the liquid situated downstream of the first zone is constituted by a screw portion of which the shaft is devoid of orifices.

### CROSS REFERENCE TO RELATED APPLICATIONS

This application claims the benefit of priority under 35 U.S.C. § 119 (a) and (b) to French Patent Application No. 2402335, filed Mar. 8, 2024, the entire contents of which are incorporated herein by reference.

### BACKGROUND

The present invention relates to devices making it possible to mix a gas into a liquid.

It is known that such processes for dissolving or enriching a liquid in or with a gas are involved in many industrial fields and in particular the aeration of wastewater, or else the preparation of carbonated drinks, or else the dissolution of gases in chemical products.

Mention may be made here of:
The dissolution of chlorine in water: Chlorine (Cl2) dissolves in water to form hypochlorous acid (HOCl) and hydrochloric acid (HCl), and this is used in the treatment of drinking water and in swimming pools to disinfect the water.
Ammonia in water: Ammonia (NH3) dissolves in water to form ammonium hydroxide (NH4OH), and this is important in the production of fertilizer and in certain chemical reactions.
Sulfur dioxide in water: Sulfur dioxide (SO2) dissolves in water to form sulfurous acid (H2SO3), and this can contribute to acid rain and other environmental problems.

In addition, the question of injecting neutral gases for deoxygenation into liquid chemical products can be useful for several reasons:
Stability: By eliminating the dissolved oxygen, the risk of oxidation of the sensitive components present in the liquid is reduced, and this can extend the shelf life of the product.
Reactivity: Certain chemical processes require the absence of oxygen to proceed effectively, and therefore deoxygenation can promote these reactions by eliminating the oxygen that could interfere.
Prevention of corrosion: In certain cases, the presence of oxygen can promote the corrosion of the containers or equipment in contact with the chemical liquid. Deoxygenation can therefore contribute to reducing this risk.
Quality of the final product: By eliminating the oxygen, it is also possible to reduce the formation of undesirable by-products that could result from undesirable reactions with the oxygen.

The operation and performance observed will depend on the design of the mixer used, which may implement nozzles, stirrers or other mechanisms so as to effectively mix the gas and the liquid.

Mention may be made here of the case of the static mixer, which is a device for continuously mixing fluids that can adopt many geometries, and in particular a tubular shape composed of a set of immobile elements placed end to end in a tube. Each element has a particular rigid geometric structure that divides the stream and recombines it. In general, the contact between the fluids takes place by virtue of the radial movement generated in the mixers. The interfacial area generated depends directly on the energy dissipated in the form of a pressure drop. The effectiveness of the operation of mixing in a static mixer depends greatly on the flow regime.

Various mixer geometries have thus been created so as to adapt in particular to laminar and turbulent flows.

Certain of these mixers have greater or lesser elongational flows. This is why they are particularly used for the mixing of polymers having high viscosity ratios and also for the production of emulsions.

Other static mixers are based essentially on shearing.

The use of static mixers is very well known, and is the subject of very abundant literature; the drawbacks of these mixers are thus well known, among which mention may be made of:
Limitations with regard to the mixtures that can be created: specifically, static mixers are not suitable for all types of mixtures, in particular when elements that are very viscous or difficult to mix are involved. They may then present difficulties or even impossibilities in allowing perfect homogeneity to be obtained.
Their size and their bulk: static mixers can be voluminous, and this can be a disadvantage if the manufacturer has space constraints.
They can also be difficult to integrate into certain overall industrial process configurations (integration made difficult by the deltaP generated, which reduces the flow rate or else requires more energy to maintain the flow rate).
Cleaning: intrinsically, owing to their very design, which is very dense and “tortuous”, cleaning static mixers can be difficult and tedious as a result of their complex design with many fins and channels. This can lead to stoppage times in production.
The initial cost: high-quality static mixers can be costly to purchase, and this can represent a high initial investment for certain companies.
Their sensitivity to fouling: as has been seen above, static mixers are sensitive to fouling by solid particles, and this can affect their mixing effectiveness over time.
A need for constant pressure or flow rate: certain static mixers require a constant flow rate or pressure to operate correctly; this can be constraining in certain applications and requires either the addition of a pump or the oversizing of the pump already in place.

### SUMMARY

As will be seen in greater detail below, the present invention endeavours to propose a novel mixing configuration, characterized in that two zones with different actions are implemented in a screw: in a first part, mixing by dilution in which the gas is progressively distributed into the liquid, followed by a second part performing mixing by division.

In addition, as will be seen, this mixer ensures a high effectiveness of enrichment of the gas with minimal hydraulic loss, and it is capable of solubilizing many gases such as carbon dioxide (CO₂), oxygen (O₂) and ozone (O₃) in water, including at the saturation limit.

This technology is very effective in waters of processes in which the solubility of the gas is limited by the operating conditions. In addition, among the operating conditions that are limiting, mention may be made of:
The distance available to have a contact time necessary for the dissolution of the gas: it is known that, depending on the circumstances, tens of metres are sometimes necessary, and this is very detrimental in terms of space.
The pressure: certain systems operate at high pressures (from atmospheric pressure to, for example, 200 bars): the present system entirely made of stainless steel makes it possible to meet pressure resistance constraints.
The temperature.
The aggressiveness of certain liquids (sodium hydroxide, acid etc.).

The mixer in accordance with the invention may be integrated into the existing pipes of the site, or else configured in a bypass loop with the aid of a pump (for example in a recirculation loop of a tank for oxygenation or for regulation in terms of pH).

The high effectiveness of this novel system is based on the principle of progressive dilution of the gas in the liquid, resulting from a large gas-liquid interface.

The gas-liquid transfer is then optimized by virtue of a division function that generates little pressure drop. The system is also resistant to abrasion.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a partial schematic view of an example of implementation in the sequence of these two zones;

FIG. 2 illustrates a representative mixing (“division”) zone.

### DETAILED DESCRIPTION OF PREFERRED EMBODIMENTS

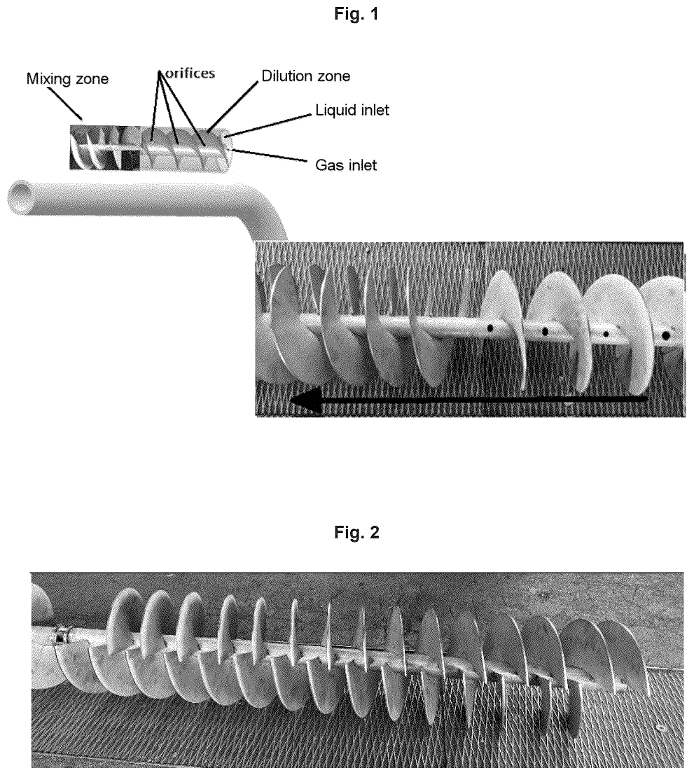

The above will be explained more clearly with the aid of the appended FIG. 1, which provides a partial schematic view of an example of implementation in the sequence of these two zones (with a zoomed-in view in the right-hand part of the figure, showing the direction of advancement of the fluid in the structure):
A first zone (first zone encountered by the fluid to be treated) is therefore visualized, which first zone has an Archimedes screw portion within which the shaft is a pipe pierced with orifices, the liquid to be treated passes through the space inside the pipe surrounding the shaft, while the gas passes inside the shaft and discharges via the orifices into the liquid surrounding the shaft; As will be explained below, this zone can be referred to as a “dilution zone”).
This first zone is followed by a second zone, which zone can be referred to as a “mixing zone” or “division zone”, as constituted only by the sequence of the blades of a screw (without gas inlet).
Dilution in the first zone, and reference can even be made to progressive dilution since with each revolution of the water in the Archimedes screw the water encounters an orifice through which the gas escapes; the gas is therefore not injected at a single point but at a succession of points. The distribution of the gas into the water is therefore progressive, so as to keep the gas bubbles separated.
Division in the second zone: the idea is to divide the “liquid/gas” stream in two at each revolution; at each revolution it divides and merges so as to be divided into two again, allowing easy mixing.

In addition, consideration can be given to the example, illustrated in the appended FIG. 2, of a mixing (“division”) zone counting, in the example shown, 15 turns, therefore 15 division operations; a given volume of water will thus be divided 15 times.

The number of orifices and the diameter of the pipe will be chosen according to the dissolution requirement. It is obvious to a person skilled in the art of gases that the more spaced-apart holes there are and the smaller the diameter of the hole, the more formation of small bubbles there is. The size of the bubbles at creation (entry into the liquid) will be at least identical or even partially already dissolved at the exit from the tube. It is therefore necessary to take care over the production of small bubbles, and to promote a high speed, preferentially a turbulent regime, in order to obtain good, forced mixing of the gas with the liquid (speed of the gas of typically 1 to 2 m/s, preferably about 2 m/s).

The invention then relates to a device for mixing a gas into a liquid, implementing a screw structure in a pipe in which the liquid is able to circulate, and also means for injecting the gas at one or more points into the pipe, it being possible for the screw to be of any type, such as an Archimedes screw or a screw with a central shaft and blades organized on this shaft, characterized in that:
two zones with different actions are implemented in the screw: in a first part, mixing by dilution in which the gas is progressively distributed into the liquid, followed by a second part performing mixing by division;
the first zone encountered by the liquid has a screw portion within which the shaft is a pipe pierced with orifices, the liquid to be treated passing through the space inside the pipe surrounding the shaft, while the gas is distributed inside the shaft and discharges via the orifices into the liquid;
the second zone situated downstream of the first zone and being perfectly adjacent thereto and in fluid communication therewith is constituted by a screw portion of which the shaft is devoid of orifices.

As has been said, the screw used can be of any type:
Endless screws: used for transporting bulk materials, such as grains, powders, or granules.
Archimedes screws: mainly used for pumping and moving liquids, such as water or viscous liquids.
Metering screws: designed to precisely meter bulk materials or liquids, often used in industrial processes.
Pressure screws: used to apply a controlled pressure to the transported materials in order to compact or expel them.

Reference herein to “one embodiment” or “an embodiment” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The singular forms “a”, “an” and “the” include plural referents, unless the context clearly dictates otherwise.

“About” or “around” or “approximately” in the text or in a claim means +10% of the value stated.

As used herein, “room temperature” in the text or in a claim means from approximately 20° C. to approximately 30° C.

The term “ambient temperature” refers to an environment temperature approximately 20° C. to approximately 30° C.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

What is claimed is:

1. A device for mixing a gas into a liquid, having a screw structure in a pipe in which the liquid is able to circulate, and also an injection device for injecting the gas at one or more points into the pipe, wherein:
two zones with different actions are implemented in the screw: in a first part of the screw, mixing by dilution in which the gas is progressively distributed into the liquid, followed by a second part of the screw performing mixing by division;
and wherein the first zone encountered by the liquid has a screw portion within which the shaft is a pipe pierced with orifices, the liquid to be treated passing through the space inside the pipe surrounding the shaft, while the gas is distributed inside the shaft and discharges via the orifices into the liquid;
wherein the second zone encountered by the liquid situated downstream of the first zone, and being in fluid communication therewith, is constituted by a screw portion of which the shaft is devoid of orifices.

2. The device according to claim 1, characterized in that the device is able to be integrated into an existing pipe of an overall installation.

3. The device according to claim 1, characterized in that the device is able to be integrated into a bypass loop of an overall installation with the aid of a pump.
